(19) United States
(12) Patent Application Publication
(10) Pub. No.: US 2024/0160461 A1
(43) Pub. Date: May 16, 2024

(54) AUTOMATED MANAGING OF UPDATES FOR REMOTE DESKTOP EXPERIENCE

(71) Applicant: MICROSOFT TECHNOLOGY LICENSING, LLC, Redmond, WA (US)

(72) Inventors: Bijayalaxmi NANDA, Edison, NJ (US); Jinhua FEI, Bellevue, WA (US); Prasanna Chromepet PADMANABHAN, Redmond, WA (US); Pavithra THIRUVENGADAM, Bellevue, WA (US)

(21) Appl. No.: 17/986,513

(22) Filed: Nov. 14, 2022

(51) Int. Cl. G06F 9/455

(52) U.S. Cl. CPC G06F 9/45558

(57) ABSTRACT

In response to a request to launch a virtual session between a virtual machine and a client machine, a determination is made regarding compatibility of corresponding components of the client and virtual machines for a particular application, and prior to the particular application being launched within the virtual session. Compatibility updates are automatically triggered responsive to detected compatibility problems. The triggered compatibility updates comprise at least one of: (i) an update at the virtual machine of an application component of the virtual machine or (ii) an update at the client machine of an optimization component of the client machine. When the triggered compatibility update does not successfully complete prior to the application being launched within the virtual session, the client and virtual machines refrain from using any of the new/updated components during the virtual session that successfully complete after the application is launched within the virtual session.

### BACKGROUND

Conventional cloud computing enables a client machine to interface with a remote host through a virtual session. During this session, a virtual machine is utilized at the remote host to provide the client machine a virtual desktop experience. During the virtual desktop experience, the client machine can access and utilize data, applications, and resources that are available to the virtual machine at the remote host. For instance, during the virtual desktop experience, it is possible for a client machine to launch and control an application running within a virtual machine hosted by a remote system, as though the application was natively running at the client machine. In this manner, the client machine can remotely leverage resources and capabilities that it may not directly possess.

Some of the application data that is remotely processed at the virtual machine will be delivered and processed at client machine for rendering at the client machine. It will be appreciated, that while the application in the virtual desktop experience is primarily executing at the virtual machine, the hardware and software components available to the client machine can also affect the manner in which the application data is ultimately processed and rendered. In this regard, it is particularly important that the components processing the application data at the backend (e.g., at the virtual machine) are compatible with the components used to process and render the data at the frontend (e.g., at the client machine). Otherwise, the client desktop experience can be significantly degraded as the client machine may not be able to process and render the data at the same resolution, speed and quality that it is currently made available by the application running at the virtual machine, if at all.

By way of example, if the application plugins and encoders used by the virtual machine are incompatible with the application plugins and decoders used by the client machine, the client machine may be incapable of processing and presenting the processed data of a virtual desktop application in an intended manner. For instance, incompatibilities between the components of the virtual and client machines can cause the application data to be presented with glitches, lags, poor formatting, poor resolution, etc.

Issues associated with incompatible components are particularly evident with media heavy applications, such as video conferencing applications, which utilize various combinations of audio and video processing components for encoding, decoding, synchronizing and rendering the application's media content.

While compatibility of application components is certainly desired, it has been found to be quite difficult to track and manage, particularly when a host system is configured to interface with many different types of client devices (e.g., mobile phones, mobile watches, laptops, tablets, kiosks, desktops, etc.) that each have unique combinations of different media processing components. Different versions and configuration settings of the same or similar components can also cause compatibility issues in some cases.

For at least these reasons, there is an ongoing need and desire for improved systems and techniques for managing component updates for client machines and remote systems involved in virtual sessions, and particularly for facilitating compatibility of the system components in an effort to promote consistent and native virtual desktop experiences.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Systems and methods are provided for controlled and automated managing of updates for virtual desktop experiences between client machines and virtual machines.

Disclosed systems are configured to make determinations regarding compatibilities between the components of a virtual machine and the corresponding components of a remote client machine for processing application data shared between the virtual machine and the client machine by a particular application utilized in a virtual session between the client machine and the virtual machine. In some instances, the determination of component compatibility is made in response to detecting a request to launch the virtual session between the client machine and the virtual machine, and prior to the particular application being launched within the virtual session.

Thereafter, in response to determining a compatibility of the corresponding components of the virtual machine and the client machine fail to satisfy a predetermined optimization threshold, the disclosed systems automatically trigger a compatibility update for the application prior to the application being launched in the virtual session. The triggered compatibility update comprises at least one of: (i) an update at the virtual machine of an application component of the virtual machine or (ii) an update at the client machine of an optimization component of the client machine.

In some instances, the disclosed systems also ensure the triggered compatibility update has successfully completed/installed prior to launching the application within the virtual session. The systems may ensure that the triggered compatibility update has successfully completed, for example, by at least causing at least one of (i) the virtual machine to update the application component of the virtual machine or (ii) the client machine to update the optimization component of the client machine prior to the particular application being launched in the virtual session.

Sometimes, the disclosed systems further ensure the triggered compatibility update has successfully completed prior to completely establishing the virtual session between the virtual machine and client machine.

In some instances, when the triggered compatibility update does not successfully complete prior to the application being launched within the virtual session, the disclosed systems cause the virtual and client machines to refrain from using any new/updated components during the virtual session that successfully complete after the application is launched.

The systems that perform the foregoing functionality can include any combination of the client machine, the system hosting the virtual machine and/or an intermediary server system interposed between the client machine and the host system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing environment that incorporates systems that comprise and/or that may be used to implement aspects of the disclosed invention;

FIG. 2 illustrates another computing environment that incorporates systems that comprise and/or that may be used to implement aspects of the disclosed invention;

FIG. 3 illustrates another computing environment that incorporates systems that comprise and/or that may be used to implement aspects of the disclosed invention;

FIG. 4A illustrates a flow diagrams of acts associated with the disclosed methods for controlled and automated managing of updates for virtual desktop experiences between client machines and virtual machines;

FIG. 4B illustrates a flow diagrams of acts associated with the disclosed methods for controlled and automated managing of updates for virtual desktop experiences between client machines and virtual machines;

FIG. 4C illustrates a flow diagrams of acts associated with the disclosed methods for controlled and automated managing of updates for virtual desktop experiences between client machines and virtual machines; and

FIG. 4D illustrates a flow diagrams of acts associated with the disclosed methods for controlled and automated managing of updates for virtual desktop experiences between client machines and virtual machines.

### DETAILED DESCRIPTION

Disclosed embodiments are provided for facilitating controlled and automated management of updates for virtual desktop experiences during virtual sessions between client machines and remotely hosted virtual machines. As described herein, the disclosed embodiments can be used to facilitate compatibility of machine components in a manner that can promote consistent and native desktop experiences during the virtual sessions.

As noted in the Background section, above, various problems are associated with the incompatibility of application components utilized by virtual machines and the corresponding components of client machines that process application data during virtual sessions between the virtual and client machines. In particular, such incompatibilities can result in the application data being processed in a degraded or undesired manner, such as with glitches, lags, poor formatting, poor resolution, etc.

In conventional systems, when an incompatibility between the components of a virtual machine and a client machine are detected during a virtual desktop experience, such as by detecting any of the aforementioned processing and rendering problems at the client machine, a user may pause execution of the application to search for and download updated drivers, plugins or other components that may be more compatible with the components of the virtual machine. However, this process is very disruptive and may require the user to manually relaunch the application within the virtual session and/or relaunch a new virtual session.

Additionally, even for scenarios in which the user or a system is able to cause the client machine to use the new components without having to relaunch the application during the virtual session, the user will still likely experience an interruption and/or inconsistency in the manner in which the data is processed and rendered on their machine, as the change in the application's processing components may occur during the rendering of the application data. It will be appreciated that such inconsistencies in the native virtual desktop experience, as well as the other problems mentioned above, can significantly degrade the overall user experience.

The disclosed embodiments provide many technical benefits over conventional cloud computing systems and can be used to address some of the aforementioned problems. For instance, the disclosed embodiments can be used to facilitate compatibility of machine components used during virtual sessions in a manner that can promote consistent and native desktop experiences during the virtual sessions.

The technical benefits include controlling the timing for identifying and triggering compatibility updates so that machines do not unnecessarily perform update processes that are not necessary for impending virtual sessions and while also triggering and/or ensuring the updates are completed prior to launching corresponding applications in the virtual sessions that rely on the updates to provide compatibility of the components used by the applications.

To facilitate the manner in which the disclosed embodiments are described, the components of a virtual machine that are utilized while processing the application data with the virtual machine will be called application components. In contrast, the components that are utilized while processing the application data with the client machine will be called optimization components.

The term processing, when used with regard to the processing of the application data, should be broadly construed to include any type of computer processing that may occur to application data including, but not limited to, encoding, decoding, compressing, decompressing, encrypting, decrypting, formatting, transmitting, receiving, storing, rendering, transcribing, translating, and so forth.

The terms compatibility and incompatibility refer to the ability in which the different application components and optimization components can communicate and/or process the application data according to common parameters and protocols.

In some instances, a particular application component will be determined to be more compatible with a first optimization component than a second optimization component when the particular application component is able to communicate more quickly and/or with less computational load with the first optimization component than is required to communicate with the second optimization component.

In other instances, a particular application component will be determined to be more compatible with a first optimization component than a second optimization component when the particular application component is able to transmit application data more quickly and/or with less computational load to the first optimization component than is required to transmit the application data to the second optimization component.

In yet other instances, a particular application component will be determined to be more compatible with a first optimization component than a second optimization component when the application data received by the particular application component in a particular format is able to be processed by the first application component in a manner specified by the application or particular application component more quickly and/or with less computational load than is required by the second optimization component.

In yet other instances, a particular application component will be determined to be more compatible with a first optimization component than a second optimization component when the application data received by the particular application component in a particular format is able to be processed by the first application component more similarly to a format and/or resolution specified by the application or particular application component than is possible with the second optimization component.

Regardless of the manner in which the compatibility of the machine components are determined, the disclosed embodiments include timing the triggering and execution of compatibility updates for the machine components in a manner that facilitates and promotes a native desktop experience during a virtual session (e.g., a consistent experience expected by the user, which is based on the rendering capabilities of the client machine, and without causing interrupts during the desktop experience for upgrading system components). The embodiments also provide methods for restricting the updating of components and/or the use of updated components during a virtual session that would interfere with the native desktop experience.

For instance, in response to a request to launch a virtual session between a virtual machine and a client machine, a determination is made regarding compatibility of corresponding components of the client and virtual machines for a particular application, and prior to the particular application being launched within the virtual session. Compatibility updates are automatically triggered responsive to detected compatibility problems. The triggered compatibility updates comprise at least one of: (i) an update at the virtual machine of an application component of the virtual machine or (ii) an update at the client machine of an optimization component of the client machine.

By waiting for a request to launch a virtual session, first, prior to checking for component compatibilities between the client machine and different virtual machines, for any number of possible applications that could be invoked and used during virtual sessions between the client machine and the different virtual machines, the systems can conserve processing that would otherwise be required to check for said updates.

When a compatibility check is finally made, and a determination is made to trigger a desired compatibility update, the systems also ensure that the triggered compatibility update is triggered prior to the application being launched within the virtual session. Likewise, in some embodiments, the systems also ensure that the application is not used during the virtual session if the update does not successfully complete prior to launching the application in the virtual session. In this manner, the systems can promote the consistent native desktop experience without causing interrupts and transitions in the manner in which the application processes and renders the application data during the virtual session.

The foregoing benefits and technical advantages will also become more apparent throughout the rest of this disclosure.

Various references have been made to application components being utilized. It will be appreciated that this reference can include any use of hardware or software by an application during execution of the application, such as for accessing, processing and/or storing data. In some instances, an application component is utilized by generating UI elements within a virtual machine. Likewise, an optimization component can be utilized by the application by displaying the UI elements at a remote client machine. By way of another example, an application component can be utilized by an application to redirect encoded data to an optimization component of a client machine, rather than decoding an encoded data stream itself. The application can also utilize the optimization component of the client machine to receive and decode the encoded data stream (e.g., a stream of audio, video, etc.)

In yet another example, an application component can be utilized by, rather using a connection for a time-sensitive connection between a virtual machine and a remote computer, causes the connection to be established between the remote computer and an optimization component of a different client machine utilizing the virtual machine to process various data in the connection (e.g., incoming or outgoing streams of audio and/or video data, indicia of user interactions, etc.).

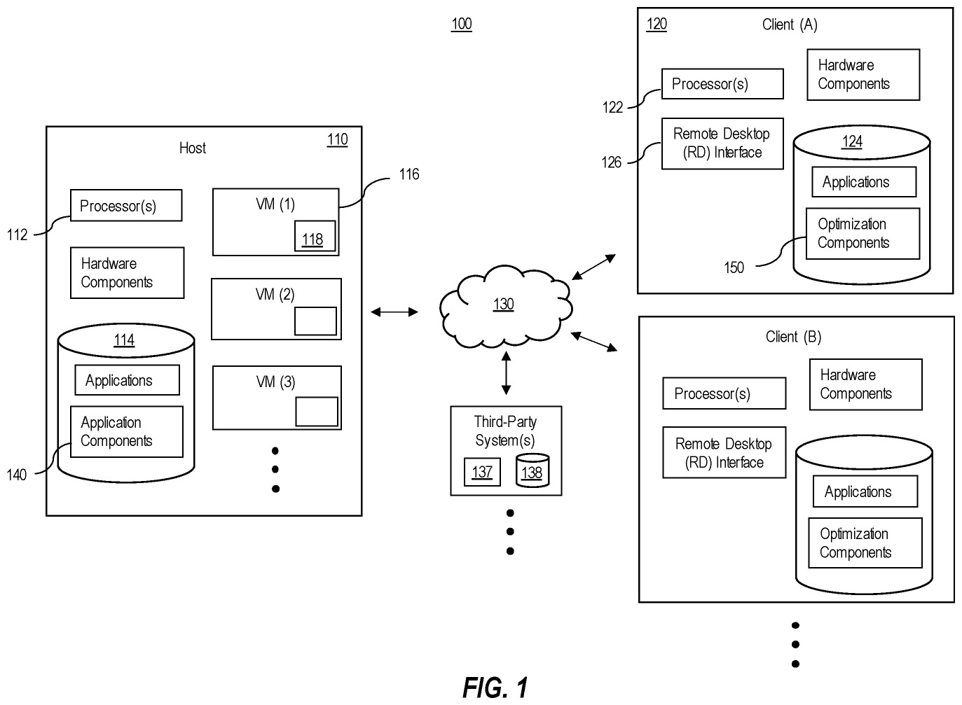

Attention will now be directed to FIG. 1. In this illustration, a computing environment 100 includes a host system 110, one or more client systems 120 (i.e., Client (A) and/or Client (B)) and one or more third-party systems. The systems are remotely connected or connectable through various wired and wireless connections 130. Each of these systems may also be configured as a stand-alone system and/or as a distributed system, with the constituent components of each system being stored in either a single location and/or distributed in different locations.

The constituent components of the systems include respective hardware processor(s) (112, 122, 137) and storage (114, 124, 138). The storage (114, 124, 138) stores code in the form of computer-executable instructions that are executed by the one or more hardware processor(s) (112, 122, 132) to implement the methods and other functionality disclosed herein.

Each of the systems also includes constituent input/output device(s) for receiving user input and for rendering output, including user input and application data. These input/output device may include, but are not limited to, the referenced software application components 140, optimization components 150, interfaces (e.g., 126), applications, and hardware components, as well as other software and hardware not specifically shown. The input/output device(s) can also comprise processing devices that do not specifically render any data, but rather process the data and input referenced herein.

The various software components, including the applications, application components and optimization components can be stored in any combination of the referenced storage units of the different systems to facilitate implementation of the disclosed embodiments.

Each of the client systems may also include a remote desktop interface 126 configured to interface with one or more virtual machines (e.g., 116) remotely hosted at the host system. In some instances, the remote desktop interface 126 is configured to establish a virtual session between a corresponding client system and a virtual machine at a host system in response to user input received at the client system comprising a request for launching a virtual session. This input may be an explicit request to launch a virtual session, a request to access a virtual machine and/or a request to access resources at the host that are available through a virtual machine.

Currently, the host 110 is shown with multiple virtual machines (e.g., VM (1), VM (2), VM(3), etc.). However, it will be appreciated that the host 110 may include only a single virtual machine 116 or any number of other virtual machines in different configurations. The host 110 may provide one or more of the virtual machines to only a single client (e.g., Client (A)), or to any combination of different clients (e.g., Client (A), Client (B), etc.). Likewise, each of the client systems can connect with one more different virtual machines and/or different hosts.

Each of the different client systems can be configured with different capabilities and may configured with different combinations of hardware components and software components (e.g., applications and optimization components). Likewise, each of the different virtual machines can be configured with different capabilities and access to different resources at the host 110, as well as different hardware and software components for interfacing with the hardware and software components of the different client systems. For instance, the virtual machines may utilize different encoders for video conferencing applications than used for VLC (VideoLAN client) applications. Likewise, a client may different decoders that are compatible with the different virtual machine encoders, depending on which applications are being used by the client.

During a virtual session, in which a client machine (e.g., Client (A) 120) is connected to a virtual machine (e.g., VM(1) 116), an application at the host can be executed within a virtual session to provide the client machine a virtual desktop experience as though the application were executing at the client machine. During the execution of the application, application data is processed with different application components at the host system and optimization components at the client machine, as previously discussed.

To help facilitate a good user experience and the processing of the application data in a desired manner, it is important to utilize compatible application components and optimization components during the virtual session. Accordingly, when an application is launched in the virtual session, the systems can identify the relevant components that will be used by the application and to make sure that they are compatible. In some instances, this means selecting the components to be used from a larger set of available components (e.g., selecting a particular encoder or decoder from a plurality of available encoders and decoders, etc.).

To assist with the tracking of which components are compatible between the different systems, various tables and directories of components and their compatibilities can be stored at any combination of the different systems and/or made available for remote access from the different systems shown.

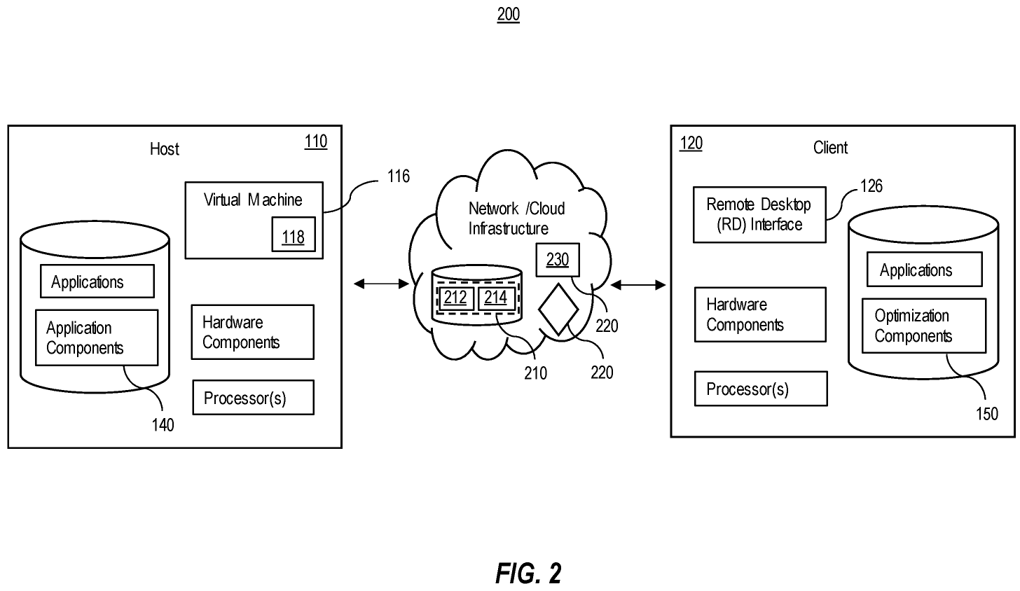

By way of example, attention is directed to the computing environment 200 of FIG. 2. In this illustration, a component compatibility index 210 or other data structure is configured with listings of application components 212 and optimization components 214. These listings identify the properties, versioning, and other information for the different components that indicate their compatibilities with other components. This information can be extracted from, reference and/or include directories and libraries of the various components that are stored at and/or made available to the different host and client systems.

In the current embodiment, the component compatibility index 210 is shown to be broadly stored within the network/cloud infrastructure. This may reflect, in some instances, that the component compatibility index 210 is stored in a server interposed between the host and client systems. However, in other instances, the component compatibility index 210 is stored at the host or client systems. It will also be appreciated that the component compatibility index 210 can be configured as either a single data structure and/or as a plurality of different data structures. When configured as a distributed data structure, the component compatibility index 210 can be stored within a single domain or in disparate locations, including at any combination of the host, client and third-party systems.

FIG. 2 also illustrates a graph API 220 that may be used to present the contents of the component compatibility index 220. This graph API 220 may be incorporated into any interface that is capable of consuming information from the component compatibility index 210 and mapping compatibilities between the different components referenced within the component compatibility index 210 based on the relationships of their corresponding protocols, capabilities, restrictions and other attributes. The graph API 220 may present the component capability information to the host and client systems when requested through an interface, such as the remote desktop interface and/or the agent 118 used by the different virtual machines for virtual sessions instantiated between the host and client systems.

The graph API 220 can be used by the decision engine 230 to determine which components are more or less compatible, incompatible and/or most compatible, when selecting different components to use for processing the application data. The decision engine 230 can also identify additional components that are not already installed or available at the different host and client systems, but which are identified as being more compatible for a particular application, and to trigger a component compatibility update in which a new component is downloaded, enabled, or otherwise made available at the respective host and/or client systems.

As with the component compatibility index 210, the decision engine 230 can be stored in a single domain and/or be distributed at multiple locations (e.g., at the host, client and/or third-party systems). For instance, the decision engine 230 can be incorporated into the decision engine 230 and/or agent 118, as well as an intermediary server system.

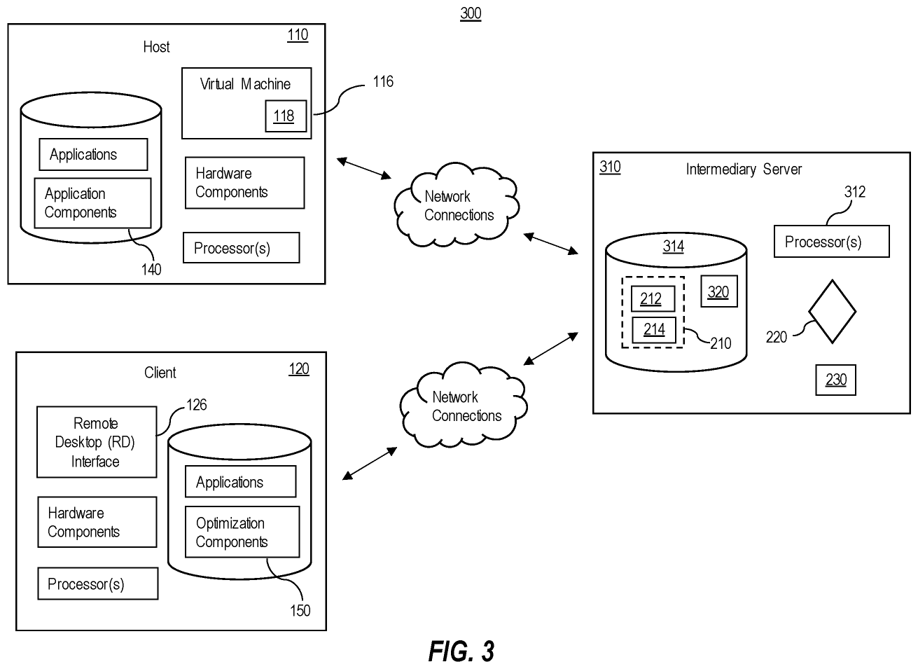

FIG. 3 illustrates a computing environment 300 in which an intermediary server 310 is interposed between the host 110 and client 120 systems and in which the component compatibility index 210, graph API 220 and decision engine 230 are stored at the intermediary server 310. The intermediary server 310 also has a hardware processor 312 and storage 314 with code 320 that is executable by the processor 312 for implementing methods and functionality disclosed herein.

The intermediary server 310 may be used to process requests for establishing virtual sessions between the host and client systems. The host 110 and client 120 are able to directly establish a virtual session with a virtual machine 116 at the host 110 without the intermediary server 310. In such instances, the intermediary server 310 may be used to present the compatibility information to the host and/or client systems through the graph API 220. The intermediary server 310 may also inform the host and/or client systems which updates are needed for any applications that may be utilized for processing application data within the virtual session. This decision can be made, for example, based on the identified capabilities of the virtual machine 116 at the host 110, specified by an agent 118 that registers the different component and application information with the registries and directories used to generate the component compatibility index 210.

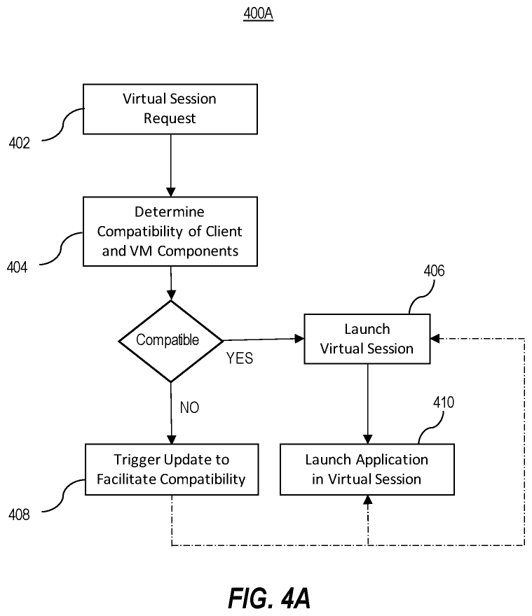

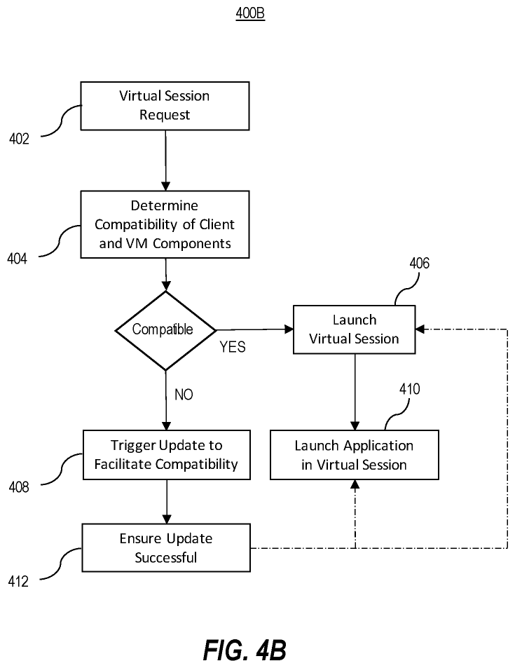

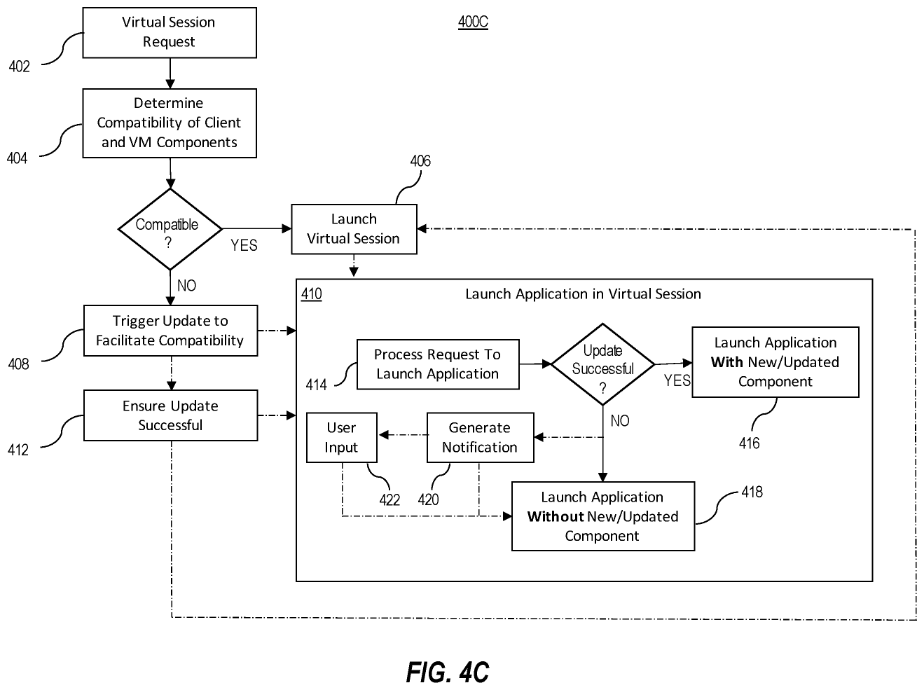

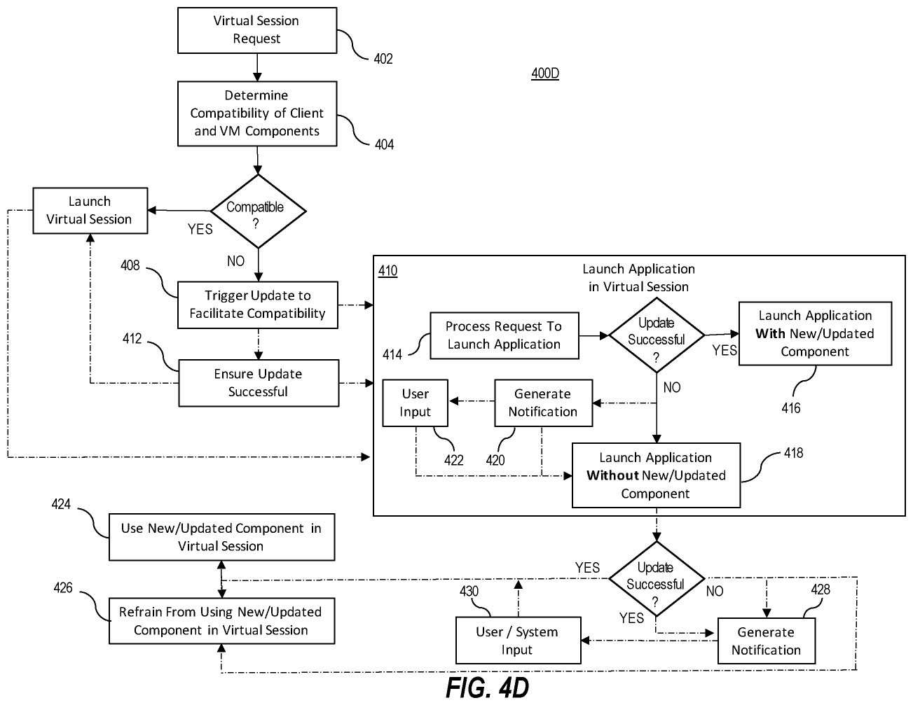

Additional details and examples of the processes that may be performed in making the decisions regarding component compatibility and managing component updates are described in more detail below, with specific reference to the flow diagrams shown in FIGS. 4A-4D.

The flow diagram 400A in FIG. 4A, for example, illustrates acts associated with methods for facilitating controlled and automated management of updates for virtual desktop experiences during virtual sessions between client machines and remotely hosted virtual machines.

The first illustrated act includes a system receiving or detecting a virtual session request (act 420). This request is a request to launch a virtual session between a client machine and a virtual machine of a remote host in which application components of the virtual machine and corresponding optimization components of the client machine are configured to process data shared between the virtual machine and the client machine by a particular application utilized in the virtual session.

The request may be an explicit request made at the client to access a virtual machine at a remote host and/or to access resources which can be made available to the client through the virtual machine, even before the virtual session has been established. This request may also be a request to access the particular application though the remote desktop interface or a different interface at the client that is associated with the particular application. The request may also simply be a user input for launching a software interface, like the remote desktop interface, or another software interface for launching a virtual session.

Then, in response to the request to the launch the virtual session, and prior to the particular application being launched within the virtual session, the system determines a compatibility of the corresponding application components of the virtual machine and the optimization components of the client machine (act 404). This may be performed, for example, by the aforementioned decision engine 230 stored at the client, host and/or intermediary server.

Then, when it is determined the compatibility of the corresponding application components of the virtual machine and the optimization components of the client machine satisfy a predetermined compatibility threshold, the system will launch the virtual session (act 406) and without triggering any update for further facilitating compatibility between the components prior to launching the virtual session.

Alternatively, when it is determined the compatibility of the corresponding application components of the virtual machine and the optimization components of the client machine fail to satisfy a predetermined compatibility threshold, the system will trigger a compatibility update prior to launching the particular application within virtual session (act 408). The triggered compatibility update is, in some instances, at least one of (i) an update at the virtual machine of an application component of the virtual machine, or (ii) an update at the client machine of an optimization component of the client machine.

It will be appreciated that the update of the application and/or optimization component may be the installation of a new component and/or the updating of an existing component and/or the reconfiguring an existing component for use with the particular application that is not currently configured for use with the particular application at the time the request for launching the virtual session is detected.

Then, as also shown, once the update has been triggered, the system will enable the launching of the application in the virtual session (act 410). Notably, the triggering of the update may occur prior to a client request to launch the application or subsequent to a request to launch the application, as long as the update is triggered prior to actually launching the application in the virtual session. In some instances, although not required, the update is also triggered prior to launching the virtual session to help further promote a consistent and native experience once the virtual session is established.

Additionally, as shown in the flow diagram 400B of FIG. 4B, the system may further ensure an update is not only triggered (act 408), but that the update has successfully completed (act 412) prior to launching the application in the virtual session (act 410) and/or even prior to launching the virtual session (406). This may include, for example, ensuring that an updated application and/or optimization component has been fulling installed and/or deployed in the respective system prior to launching an application in the virtual session or prior to launching the virtual session to further promote a consistent and native experience once the virtual session is established.

Although not shown, in some instances, the system may also use the decision engine or another module to track user/client system usage patterns and stored user preferences, as well as client system configurations and host system configurations, to identify applications that a client system/user may likely request during a virtual session in an anticipated virtual session and application use. Then, based on this anticipation of a virtual session and particular application use, the system may determine the compatibility of the client system optimization components and the application components of the virtual system that are associated with the anticipated application use. In this regard, the anticipated use may, in some instances, be considered an actual virtual session request and/or at least replace the virtual session request (402) in the flow diagram 400B for triggering the determination of compatibility (406) and the subsequent triggering of the compatibility update (408).

FIG. 4C illustrates another related flow diagram 400C in which timing for launching of the application in the virtual session (act 410) is deterministically based on whether the triggered update has successfully completed and in which an explicit request to launch the application in the virtual session has been processed or at least detected (act 414).

In this example, after the request to launch the application is detected (act 414), the system determines whether the previously triggered update has completed prior to launching the particular application in the virtual session and based on that determination will control the manner in which the application is launched. For instance, when it is determined that the update has successfully completed, the system will launch the application with the new or updated component (act 416). Alternatively, when it is determined that the update has not successfully completed, the system will launch the application without the new or updated component (act 418).

The system may also generate a notification (act 420) to notify a user of a failed update. Then, the user may provide input (act 422) that dismisses the notification and/or that triggers a different process, such as a termination of the virtual session, a request to launch a different application, a new request for a different or the same component, etc.

FIG. 4D illustrates yet another related flow diagram 400D in which the application is lunched without the new/updated component (act 418), such as may occur when an update fails. The update failure may be a result of a critical failure (e.g., the update is not accessible or capable of being applied) or a time out failure (e.g., the update fails to complete within a predetermined number of tries and/or within a predetermined duration of time and/or at least prior to the application being launched within the virtual session).

Regardless of the reason why the update did not successfully complete prior to the application being launched, they system may make additional determinations about whether the update has successfully completed during the virtual session, prior to the virtual session being terminated.

In this example, as shown, a subsequent determination of an update being successfully completed or not can result in the generation of a notification to a user and/or client system (act 428). To preserve the consistent native desktop experience, it is sometimes desirable to refrain from notifying a user of this status information. In some alternative embodiments, a user can configure their system to receive update status information to know about potentially enhanced virtual desktop experiences associated with updates that are successfully completed and made available for use, even if it means there may be an interruption in their desktop experience when transitioning to the enhanced configuration.

Based on detecting any user input or system input (act 430), which may be provided in the background without a user's knowledge or awareness of the update or system input, the system will either use (act 424) or refrain from using (act 426) the new/updated component in the virtual session.

In some instances, the system causes the new/updated component to be used when it is not detectable to the user, so as to preserve the native desktop experience. By way of example, if a user has launched a multimedia application within the virtual session that utilizes audio and video processing components, but the user has not used the application to play any audio yet (e.g., has had the mute button applied at their device), the system might determine that audio drivers or a language vocoder that has been updated subsequent to the launching of the application in the virtual session should be deployed and activated for use with the application during the virtual session. This determination will result in a replacement of a previously deployed and activated audio component that is determined to be less compatible with the application components of the virtual machine that is currently executing the application in virtual session and without causing a disruption to the native virtual desktop experience.

Additionally, if a user pauses the use of an application in the virtual session (e.g., puts the application in the background of the virtual desktop and/or applies focus to a different application in the virtual session), the system may apply the new/updated components for the paused application, such that they will be ready for use when the application is moved back into the foreground/focus for use.

The system may also deploy and apply any updates for the application during a virtual session if the application is ever closed and relaunched by the user within the same virtual session.

Notably, however, if it is ever determined that the use of a new/updated component will cause a disruption of the virtual desktop experience, such as with notifications that are undesired and/or by causing a change in the manner in which the application data is presented with an undesired or perceptible transition, the system may ensure that the new/updated component resulting from the triggered update is not used during the virtual session. This can help preserve a consistent and native virtual desktop experience for a user during the virtual session, even if it is not as enhanced as it possibly could be. However, this is not necessarily bad, as the consistency in which data is presented is sometimes more desired by users than incrementally enhanced performance or resolution of the data.

In some alternative embodiments, not explicitly shown, the system may determine to use a downgraded component rather than an available upgraded component to facilitate compatibility between the application components used at the virtual machine and the optimization components used at the client machine. For instance, when the application is launched within the virtual session, the system may cause the virtual machine to select and use a downgraded component (e.g., component that provides reduced resolution or other rendering capabilities or a reduction in functionality), such as an older version of a component (e.g., smaller semver number) of a component, when it is determined the downgraded component is compatible with a current client optimization component, and even though a newer and/or enhanced version of the component that is available to the virtual machine at the host system which would also be compatible with the client machine. This may occur, for example, rather than requiring a client machine to try to upgrade their application components in view of restrictions at the client machine (e.g., limited device capabilities, user restrictions, time limitations, etc.).

The system may also cause the virtual machine to select and use a downgraded version of an application component, even though an enhanced or newer version is available, when it is determined the downgraded version is more compatible with the optimization component(s) of the client machine than the enhanced or newer version of the application component(s). This determination may be made to satisfy a predetermined optimization threshold, wherein the predetermined optimization threshold is predetermined threshold of compatibility between the application component(s) and the optimization component(s). This threshold may comprise the ability for the application component(s) and the optimization component(s) to utilize a certain percentage of their functionality and/or to perform their functions with a certain quality of service and/or at a certain efficiency and/or below a certain processor or memory utilization.

The predetermined optimization threshold may also be used by the system to determine whether the update has been successful. In particular, the system may determine that the update is only successful when the update results in a compatibility that satisfies the predetermined optimization threshold. This predetermined optimization threshold can be specified by the user prior to or during the virtual session.

With regard to all of the foregoing, it will be appreciated that the disclosed embodiments may include or be practiced by or implemented by any combination of the referenced host, client and/or intermediary server and third-party system.

Each of these systems, as disclosed, is configured with one or more processors and computer-readable media such as computer memory that stores computer-executable instructions that, when executed by one or more processors, cause various functions to be performed, such as the acts recited above.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method implemented for automated managing of updates for a virtual desktop experience between a client machine and a virtual machine at a remote host, the method comprising:
detecting a request to launch a virtual session between a client machine and a virtual machine of a remote host in which application components of the virtual machine and corresponding optimization components of the client machine are configured to process data shared between the virtual machine and the client machine by a particular application utilized in the virtual session;
in response to the request to launch the virtual session, and prior to the particular application being launched within the virtual session, determining a compatibility of the corresponding application components of the virtual machine and the optimization components of the client machine; and
automatically, in response to determining the compatibility of the corresponding application components of the virtual machine and the optimization components client machine fail to satisfy a predetermined optimization threshold, and prior to the particular application being launched in the virtual session, triggering a compatibility update comprising at least one of: (i) an update at the virtual machine of an application component of the virtual machine or (ii) an update at the client machine of an optimization component of the client machine.

2. The method of claim 1, wherein the method further comprises ensuring the compatibility of the corresponding application components of the virtual machine and the optimization components of the client machine satisfy the predetermined optimization threshold, prior to the particular application being launched within the virtual session, by causing at least one of (i) the virtual machine to update the application component of the virtual machine or (ii) the client machine to update the optimization component of the client machine prior to the particular application being launched in the virtual session.

3. The method of claim 2, wherein the method comprises causing the virtual machine to update the application component of the virtual machine prior to the particular application being launched within the virtual session.

4. The method of claim 2, wherein the method comprises causing the client machine to update the optimization component of the client machine prior to the particular application being launched within the virtual session.

5. The method of claim 2, wherein the method comprises causing, prior to the particular application being launched within the virtual session, both (i) the client machine to update the optimization component of the client machine and (ii) the virtual machine to update the application component of the virtual machine.

6. The method of claim 1, wherein the method comprises:
triggering the client machine to update the optimization component of the client machine prior to the particular application being launched within the virtual session;
determining the client machine is unable to update the optimization component of the client machine prior to the particular application being launched within the virtual session; and
when the application is launched within the virtual session, causing the virtual machine to select and use a different application component for the particular application, rather than an upgraded application component for the particular application that is also available to the virtual machine.

7. The method of claim 6, wherein a determination the client machine is unable to update the optimization component of the client machine prior to the particular application being launched within the virtual session is made in response to determining the client machine has not successfully updated the optimization component of the client machine within a predetermined time threshold after the triggering.

8. The method of claim 1, wherein the method further comprises:
subsequent to the request to launch the virtual session, detecting a request to launch the particular application within the virtual session;
subsequent to the request to launch the particular application, determining whether the compatibility update has completed that has resulted in an availability of an updated component for the application during the session, the updated component comprising (i) a new or updated application component for the virtual machine or (ii) a new or updated optimization component for the client machine; and either
(i) in response to determining the compatibility update has completed prior to launching the particular application, the method comprises causing the application to launch and to use the updated component during the virtual session, or alternatively,
(ii) in response to determining the compatibility update has not completed prior to launching the particular application, causing the application to launch and to refrain from using the updated component during the virtual session, even when it is subsequently determined that the updated component is available during the virtual session as a result of the compatibility update completing subsequent to the application being launched and prior to completing the virtual session.

9. The method of claim 8, wherein the method comprises:
determining the compatibility update has completed subsequent to launching the particular application and ensuring the application refrains from using the updated component during the virtual session.

10. The method of claim 1, wherein the method further comprises:
subsequent to the request to launch the virtual session, detecting a request to launch the particular application within the virtual session;
subsequent to the request to launch the particular application, determining whether the compatibility update has completed that has resulted in an availability of an updated component for the application during the session, the updated component comprising (i) a new or updated application component for the virtual machine or (ii) a new or updated optimization component for the client machine;
determining the compatibility update has completed during the virtual session subsequent to launching the particular application; and
generating a notification to a user notifying the user of the compatibility update.

11. The method of claim 10, wherein the method further includes receiving user input for causing the application to use the updated component in the virtual session.

12. The method of claim 1, wherein the method further comprises determining the compatibility of the corresponding application components of the virtual machine and the client machine based on a comparison of a virtual machine library with a client machine library.

13. The method of claim 1, wherein the method further comprises automatically determining the compatibility of the corresponding application components of the virtual machine and the optimization components of the client machine prior to any request being made for launching the particular application within the virtual session.

14. The method of claim 1, wherein the method further comprises, subsequent to the virtual session ending and prior to the particular application being launched in a new virtual session, causing at least one of (i) the virtual machine to update the application component of the virtual machine or (ii) the client machine to update the optimization component of the client machine.

15. The method of claim 1, wherein the method is performed by the client machine, such that the client machine performs said (i) detecting the request to launch the virtual session, (ii) determining the compatibility of the corresponding application components, and (iii) triggering the application component update.

16. The method of claim 1, wherein the method is performed by the remote host, such that the remote host performs said (i) detecting the request to launch the virtual session, (ii) determining the compatibility of the corresponding application components, and (iii) triggering the application component update.

17. The method of claim 1, wherein a server is interposed between the client machine and the remote host, and the method is performed by the server, such that the server performs said (i) detecting the request to launch the virtual session, (ii) determining the compatibility of the corresponding application components, and (iii) triggering the application component update.

18. A computing system comprising:
one or more hardware processors; and
one or more storage devices storing computer-executable instructions for implementing a method for automated managing of updates for a virtual desktop experience between a client machine and a virtual machine at a remote host, wherein the method comprises:
detecting a request to launch a virtual session between the client machine and the virtual machine, the virtual machine comprising application components and the client machine comprising corresponding optimization components for processing data utilized by a particular application during the virtual session;
in response to the request to launch the virtual session, and prior to launching the particular application within the virtual session, determining a compatibility of the corresponding application components of the virtual machine and the optimization components of the client machine; and
automatically, in response to determining the compatibility of the corresponding application components of the virtual machine and the optimization components client machine fail to satisfy a predetermined optimization threshold, and prior to the particular application being launched in the virtual session, triggering a compatibility update comprising at least one of: (i) an update at the virtual machine of an application component of the virtual machine or (ii) an update at the client machine of an optimization component of the client machine.

19. The computing system of claim 18, wherein the computing system comprises the client machine, such that the client machine is configured to perform said (i) detecting the request to launch the virtual session, (ii) determining the compatibility of the corresponding application components, and (iii) triggering the application component update.

20. The computing system of claim 18, wherein the computing system comprises the remote host, such that the remote host is configured to perform said (i) detecting the request to launch the virtual session, (ii) determining the compatibility of the corresponding application components, and (iii) triggering the application component update.

21. The computing system of claim 18, wherein the computing system comprises a server interposed between the client machine and the remote host, and such that the server is configured to perform said (i) detecting the request to launch the virtual session, (ii) determining the compatibility of the corresponding application components, and (iii) triggering the application component update.
